(19) United States
(12) Patent Application Publication
(10) Pub. No.: US 2020/0035207 A1
(43) Pub. Date: Jan. 30, 2020

(54) DISPLAY CONTROL APPARATUS

(71) Applicant: AISIN SEIKI KABUSHIKI KAISHA, Kariya-shi, Aichi (JP)

(72) Inventors: Tetsuya MARUOKA, Okazaki-shi (JP); Itsuko OHASHI, Nagoya-shi (JP); Kazuya WATANABE, Anjo-shi (JP); Yoji INUI, Ama-gun (JP); Kinji YAMAMOTO, Anjo-shi (JP); Takashi HIRAMAKI, Nagoya-shi (JP); Takuya HASHIKAWA, Nagoya-shi (JP); Naotaka KUBOTA, Kariya-shi (JP); Osamu KIMURA, Nagoya-shi (JP)

(73) Assignee: AISIN SEIKI KABUSHIKI KAISHA, Kariya-shi, Aichi (JP)

(21) Appl. No.: 16/337,174

(22) PCT Filed: Mar. 24, 2017
(86) PCT No.: PCT/JP2017/012069

§ 371 Date: Mar. 27, 2019

(30) Foreign Application Priority Data
Sep. 30, 2016 (JP) 2016-194362

(51) Int. Cl. G09G 5/377; G09G 5/38; G06T 7/70; G06T 17/00; B60R 1/00

(52) U.S. Cl. CPC G09G 5/377; G09G 5/38; G06T 7/70; B60R 2300/304; B60R 1/00; G06T 2207/30252; G09G 2354/00; G06T 17/00

(57) ABSTRACT

A display control apparatus according to an embodiment includes: an acquisition unit configured to acquire predetermined data and imaged image data from an imaging unit that images a periphery of a vehicle; a storage unit configured to store therein vehicle shape data expressing a three-dimensional shape of the vehicle; and a display processor configured to switch transparency of the vehicle shape data based on the predetermined data when the vehicle shape data is superimposed and displayed on display data expressing the periphery of the vehicle based on the imaged image data.

### TECHNICAL FIELD

Embodiments of the present invention relate to a display control apparatus.

### BACKGROUND ART

Conventionally, a technique of imaging a peripheral environment of a vehicle by an imaging device installed on the vehicle and displaying an image as an imaging result has been proposed.

There is a technique of superimposing and displaying a vehicle cabin and the vehicle on image data provided by imaging the peripheral environment when the peripheral environment is displayed.

### CITATION LIST

### Patent Literature

Patent Document 1: Japanese Patent Application Laid-open No. 2014-60646

### SUMMARY OF INVENTION

### Problem to be Solved by the Invention

In the conventional technique, a technique of changing transparency for each region of the vehicle cabin is proposed in order to enable the peripheral environment to be recognized when an image of the vehicle cabin is superimposed onto the image data expressing the peripheral environment. However, the technique does not take into consideration the case where vehicle shape data expressing a three-dimensional shape of the vehicle is superimposed onto the image data expressing the peripheral environment.

The present invention has been made in view of the above-mentioned circumstances and it is an object to provide a display control apparatus enabling a peripheral environment to be recognized even when vehicle shape data is superimposed thereon.

### Means for Solving Problem

A display control apparatus according to embodiments may include: an acquisition unit configured to acquire predetermined data and imaged image data from an imaging unit that images a periphery of a vehicle; a storage unit configured to store therein vehicle shape data expressing a three-dimensional shape of the vehicle; and a display processor configured to switch transparency of the vehicle shape data based on the predetermined data when the vehicle shape data is superimposed and displayed on display data expressing the periphery of the vehicle based on the imaged image data. With this configuration, the vehicle shape data and the periphery of the vehicle can be displayed depending on a current situation by switching the transparency of the vehicle shape data based on the predetermined data, thereby improving the convenience of a driver.

In the display control apparatus according to embodiments, the acquisition unit may acquire, as the predetermined data, detection data from a detector configured to detect an object on the periphery of the vehicle, and the display processor may switch the transparency of the vehicle shape data when a determination unit, which is configured to determine whether a distance between the object detected from the detection data and the vehicle is within a predetermined value, determines that the distance is within the predetermined value. With this configuration, the vehicle shape data and the periphery of the vehicle can be displayed depending on the current situation by switching the transparency of the vehicle shape data depending on a positional relation between the object on the periphery of the vehicle and the vehicle, thereby improving the convenience of the driver.

In the display control apparatus according to embodiments, the display processor may switch the transparency of the vehicle shape data depending on the distance. With this configuration, the driver can recognize the switching of the transparency depending on the distance, thereby improving the convenience.

In the display control apparatus according to embodiments, the acquisition unit may acquire, as the predetermined data, operation data indicating an enlargement operation or a reduction operation, and the display processor may display, when the operation data is acquired, the display data on which the vehicle shape data switched to have transparency differing from the transparency of the vehicle shape data before the enlargement operation or the reduction operation has been superimposed. With this configuration, the driver can check enlargement and reduction of the vehicle shape data with the switching of the transparency of the vehicle shape data, thereby improving the convenience.

In the display control apparatus according to embodiments, when enlarging and displaying the display data based on the operation data, the display processor may display the display data on which the vehicle shape data switched to have higher transparency than the transparency before the enlargement operation has been superimposed, when reducing and displaying the display data based on the operation data, the display processor may display the display data on which the vehicle shape data switched to have lower transparency than the transparency before the reduction operation has been superimposed. With this configuration, the vehicle shape data and the periphery of the vehicle can be displayed in response to the operation by the driver by switching the transparency in accordance with the enlargement and reduction, thereby improving the convenience of the driver.

In the display control apparatus according to embodiments, when enlarging and displaying the display data based on the operation data, the display processor may move a gazing point indicating a point serving as a center of display to predetermined coordinates. With this configuration, the vehicle shape data and the periphery of the vehicle can be displayed in response to the operation by the driver by moving the gazing point to the predetermined coordinates in the enlargement display, thereby improving the convenience of the driver.

In the display control apparatus according to embodiments, while an operation of moving the vehicle shape data is performed based on the operation data, the display processor may display the display data on which the vehicle shape data switched to have higher transparency than the transparency before the operation has been superimposed. With this configuration, the driver can check the periphery of the vehicle through the transparent vehicle shape data while moving the vehicle shape data, thereby improving the convenience.

In the display control apparatus according to embodiments, the display processor may display the vehicle shape data having the transparency switched depending on a display destination on which the display data is displayed.

With this configuration, display depending on characteristics of a display destination can be made, thereby improving visibility.

### BRIEF DESCRIPTION OF DRAWINGS

FIG. 1 is a perspective view illustrating an example of a state in which a part of a vehicle cabin of a vehicle on which a display control apparatus according to an embodiment is mounted is seen through.

FIG. 2 is a plan view (bird's-eye view) illustrating an example of the vehicle on which the display control apparatus in the embodiment is mounted.

FIG. 3 is a block diagram illustrating an example of the configuration of a display control system including the display control apparatus in the embodiment.

FIG. 4 is a block diagram illustrating the functional configuration of an electronic control unit (ECU) as the display control apparatus in the embodiment.

FIG. 5 is a view illustrating vehicle shape data stored in a vehicle shape data storage unit in the embodiment.

FIG. 6 is a view illustrating the vehicle shape data when a region corresponding to a portion of the vehicle with a height equal to or higher than 2 m is made complete transparent.

FIG. 7 is a view illustrating the vehicle shape data when a region corresponding to a portion of the vehicle with a height equal to or higher than 1 m is made complete transparent.

FIG. 8 is a view illustrating the vehicle shape data when a region of the vehicle on the rear side relative to a predetermined position is made complete transparent;

FIG. 9 is a view illustrating the vehicle shape data when a region corresponding to a portion of the vehicle with a height equal to or lower than 1 m is made complete transparent.

FIG. 10 is an exemplary and schematic descriptive view for explaining projection of pieces of shot image data on a virtual projection surface in an image synthesizing unit in the embodiment.

FIG. 11 is a schematic and exemplary side view illustrating the vehicle shape data and the virtual projection surface.

FIG. 12 is a view illustrating an example of viewpoint image data that a display processor in the embodiment displays.

FIG. 13 is a view illustrating another example of the viewpoint image data that the display processor in the embodiment displays.

FIG. 14 is a view illustrating another example of the viewpoint image data that the display processor in the embodiment displays.

FIG. 15 is a view illustrating another example of the viewpoint image data that the display processor in the embodiment displays.

FIG. 16 is a view illustrating another example of the viewpoint image data that the display processor in the embodiment displays.

FIG. 17 is a flowchart illustrating procedures of first display processing in the ECU in the embodiment.

FIG. 18 is a flowchart illustrating procedures of second display processing in the ECU in the embodiment.

FIG. 19 is a flowchart illustrating procedures of third display processing in the ECU in the embodiment.

FIG. 20 is a view illustrating a contact point between a wheel and ground as a reference of the height of the vehicle in the embodiment.

FIG. 21 is a view illustrating a horizontal surface as a reference of the height of the vehicle according to a first modification.

FIG. 22 is a view illustrating a display screen that a display processor in a modification displays.

### DESCRIPTION OF EMBODIMENTS

Hereinafter, an exemplary embodiment of the present invention will be disclosed. The configuration in the following embodiment and operations, results, and effects that are provided by the configuration are examples. The present invention can be implemented also by configurations other than that disclosed in the following embodiment and can provide at least one of the various effects based on the basic configuration and derivative effects.

In the embodiment, a vehicle 1 on which a display control apparatus (display control system) is mounted may be, for example, an automobile using an internal combustion engine (not illustrated) as a driving source, that is, an internal combustion engine automobile, or an automobile using an electric motor (not illustrated) as a driving source, that is, an electric automobile or a fuel cell automobile. Alternatively, the vehicle 1 may be a hybrid automobile using both of them as driving sources or an automobile including another driving source. Various types of transmissions can be mounted on the vehicle 1 and various devices such as systems and parts necessary for driving the internal combustion engine or the electric motor can be mounted thereon. A four-wheel drive vehicle of transmitting driving force to all of the four wheels 3 to use all of the four wheels as driving wheels can be employed as a driving system. Systems, the numbers, layouts, and the like of the devices related to driving of the wheels 3 can be variously set. The driving system is also not limited to the four-wheel drive system, and may be, for example, a front-wheel drive system or a rear-wheel drive system.

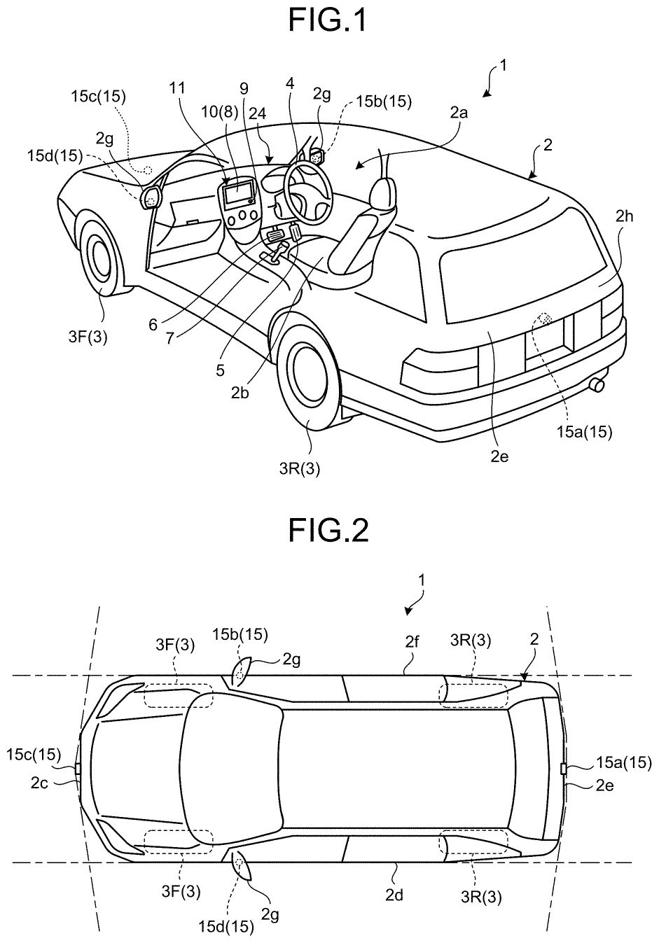

As illustrated in FIG. 1, a vehicle body 2 configures a vehicle cabin 2a in which passengers (not illustrated) get. A steering portion 4, an acceleration operation portion 5, a braking operation portion 6, a gear shift operation portion 7, and the like are provided in the vehicle cabin 2a in a state of facing a seat 2b of a driver as the passenger. The steering portion 4 is, for example, a steering wheel projecting from a dashboard 24, the acceleration operation portion 5 is, for example, an acceleration pedal located around the feet of the driver, the braking operation portion 6 is, for example, a brake pedal located around the feet of the driver, and the gear shift operation portion 7 is, for example, a shift lever projecting from a center console. It should be noted that the steering portion 4, the acceleration operation portion 5, the braking operation portion 6, the gear shift operation portion 7, and the like are not limited thereto.

A display device 8 and an audio output device 9 are provided in the vehicle cabin 2a. The display device 8 is, for example, a liquid crystal display (LCD) or an organic electroluminescent display (GELD). The audio output device 9 is, for example, a speaker. The display device 8 is, for example, covered by a transparent operation input portion 10 such as a touch panel. The passenger can visually check an image displayed on a display screen of the display device 8 through the operation input portion 10. The passenger can execute operation input by operating the operation input portion 10 by touching, pressing, or moving it with fingers or the like at a position corresponding to the image displayed on the display screen of the display device 8. The display device 8, the audio output device 9, the operation input portion 10, and the like are provided in a monitor device 11 located at a center portion in the vehicle width direction, that is, the right-and-left direction of the dashboard 24. The monitor device 11 can have an operation input portion (not illustrated) such as a switch, a dial, a joystick, and a push button. An audio output device (not illustrated) can be provided at another position in the vehicle cabin 2a, which differs from the monitor device 11, or audio can be output from the audio output device 9 in the monitor device 11 and another audio output device. The monitor device 11 can also serve as, for example, a navigation system and an audio system.

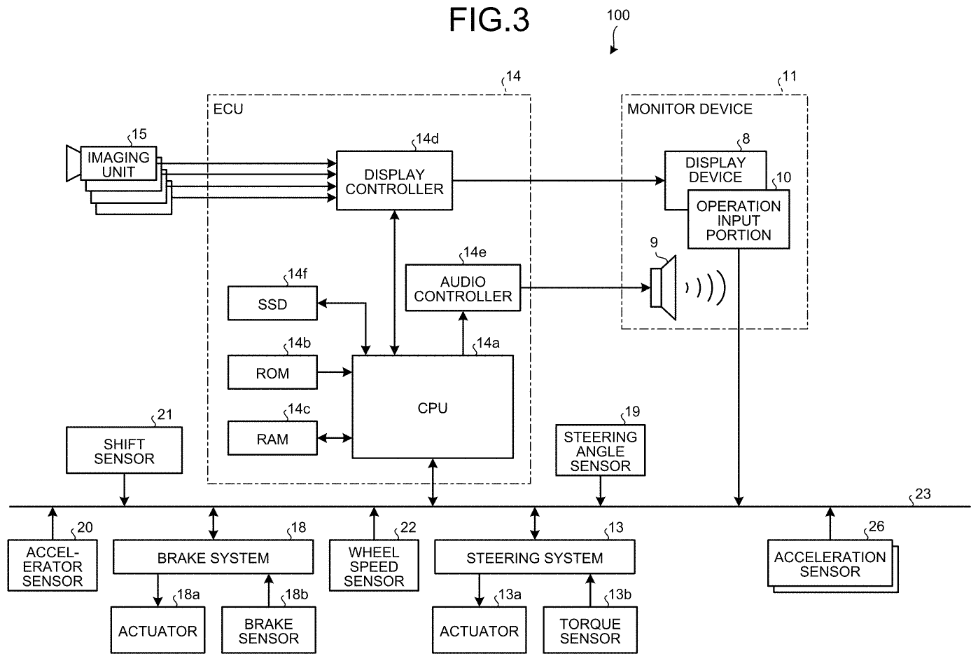

As illustrated in FIGS. 1 and 2, the vehicle 1 is, for example, a four-wheel automobile and includes two right and left front wheels 3F and two right and left rear wheels 3R. All of these four wheels 3 can be configured to be capable of being steered. As illustrated in FIG. 3, the vehicle 1 includes a steering system 13 for steering at least two of the wheels 3. The steering system 13 includes an actuator 13a and a torque sensor 13b. The steering system 13 operates the actuator 13a under electric control by an electronic control unit (ECU) 14 or the like. The steering system 13 is, for example, an electric power steering system or a steer-by-wire (SBW) system. The steering system 13 adds torque, that is, assist torque to the steering portion 4 to compensate steering force by the actuator 13a or turns the wheels 3 by the actuator 13a. In this case, the actuator 13a may turn one of the wheels 3 or turn a plurality of the wheels 3. The torque sensor 13b, for example, detects torque that the driver applies to the steering portion 4.

As illustrated in FIG. 2, for example, four imaging units 15a to 15d as a plurality of imaging units 15 are provided on the vehicle body 2. The imaging units 15 are, for example, digital cameras incorporating imaging elements such as charge coupled devices (CCDs) and CMOS image sensors (CISs). The imaging units 15 can output moving image data (imaged image data) at a predetermined frame rate. The imaging units 15 have wide-angle lenses or fish-eye lenses and can shoot a range of, for example, 140° to 220° in the horizontal direction. Optical axes of the imaging units 15 can be set obliquely downward. The imaging units 15 sequentially shoot an external environment on the periphery of the vehicle 1 that includes a road surface on which the vehicle 1 can move and peripheral objects (obstacles, rocks, recesses, puddles, ruts, and the like), and output them as pieces of imaged image data.

The imaging unit 15a is located on, for example, an end portion 2e on the rear side of the vehicle body 2 and is provided on a lower wall portion of a rear window of a rear hatch door 2h. The imaging unit 15b is located on, for example, an end portion 2f on the right side of the vehicle body 2 and is provided on a door mirror 2g on the right side. The imaging unit 15c is located on, for example, an end portion 2c on the front side of the vehicle body 2, that is, on the front side in the vehicle front-rear direction and is provided on a front bumper, a front grill, or the like. The imaging unit 15d is located on, for example, an end portion 2d on the left side of the vehicle body 2 and is provided on the door mirror 2g on the left side. The ECU 14 configuring a display control system 100 can execute operation processing and image processing based on the pieces of imaged image data provided by the imaging units 15 to generate an image with a wide viewing angle or generate a virtual overhead image when the vehicle 1 is seen from above. The ECU 14 executes operation processing and image processing on pieces of wide-angle image data provided by the imaging units 15 to generate an image by cutting a specific region, generate image data indicating only a specific region, or generate image data in which only a specific region is highlighted. The ECU 14 can convert the pieces of imaged image data into pieces of virtual image data as imaged from virtual viewpoints differing from viewpoints with which the imaging units 15 have imaged (viewpoint conversion). The ECU 14 displays the pieces of acquired image data on the display device 8 to thereby provide, for example, peripheral monitoring information enabling safety checking of right and left sides of the vehicle 1 and safety checking of the periphery of the vehicle 1 from an overhead view.

As illustrated in FIG. 3, in the display control system 100 (display control apparatus), in addition to the ECU 14, the monitor device 11, the steering system 13, and the like, a brake system 18, a steering angle sensor 19, an accelerator sensor 20, a shift sensor 21, a wheel speed sensor 22, an acceleration sensor 26, and the like are electrically connected via an in-vehicle network 23 as an electric communication line. The in-vehicle network 23 is configured as, for example, a controller area network (CAN). The ECU 14 can control the steering system 13, the brake system 18, and the like by transmitting control signals thereto via the in-vehicle network 23. The ECU 14 can receive detection results of the torque sensor 13b, a brake sensor 18b, the steering angle sensor 19, the accelerator sensor 20, the shift sensor 21, the wheel speed sensor 22, the acceleration sensor 26, and the like, operation signals of the operation input portion 10 and the like, and other pieces of information via the in-vehicle network 23.

The ECU 14 includes, for example, a central processing unit (CPU) 14a, a read only memory (ROM) 14b, a random access memory (RAM) 14c, a display controller 14d, an audio controller 14e, and a solid state drive (SSD) 14f (flash memory). The CPU 14a reads a program stored (installed) in a non-volatile storage device such as the ROM 14b and executes operation processing in accordance with the program. The CPU 14a executes, for example, image processing related to the image that is displayed on the display device 8. The CPU 14a, for example, executes operation processing and image processing on the pieces of imaged image data imaged by the imaging units 15 to detect whether a specific region to which attention should be paid is present on an estimated course of the vehicle 1 or notify a user (the driver and the passengers) of presence of the specific region to which attention should be paid by changing a display mode of a course indicator (estimated course line) indicating the estimated traveling direction of the vehicle 1, for example.

The RAM 14c temporarily stores therein various pieces of data that are used for operation in the CPU 14a. The display controller 14d mainly executes image processing using the pieces of imaged image data provided by the imaging units 15, image processing (as an example, image synthesis) of image data that is displayed on the display device 8, and the like, in the operation processing in the ECU 14. The audio controller 14e mainly executes processing of audio data that is output from the audio output device 9, in the operation processing in the ECU 14. The SSD 14f is a non-volatile rewritable storage unit and can store therein data even when the ECU 14 is powered OFF. The CPU 14a, the ROM 14b, the RAM 14c, and the like can be integrated in the same package. The ECU 14 may use another logical operation processor or another logical circuit such as a digital signal processor (DSP) instead of the CPU 14a. Furthermore, a hard disk drive (HDD) may be provided instead of the SSD 14f, and the SSD 14f or the HDD may be provided separately from the ECU 14 for peripheral monitoring.

The brake system 18 is, for example, an anti-lock brake system (ABS) preventing locking of the brake, an electronic stability control (ESC) preventing sideslip of the vehicle 1 in cornering, an electric brake system (executing brake assist) increasing braking force, or a brake-by-wire (BBW). The brake system 18 applies braking force to the wheels 3, and eventually to the vehicle 1, through an actuator 18a. The brake system 18 can detect locking of the brake, idling of the wheels 3, symptoms of the sideslip, and the like based on rotational difference between the right and left wheels 3 and execute various controls. The brake sensor 18b is, for example, a sensor that detects a position of a movable portion of the braking operation portion 6. The brake sensor 18b can detect the position of the brake pedal as the movable portion. The brake sensor 18b includes a displacement sensor.

The steering angle sensor 19 is, for example, a sensor that detects the steering amount of the steering portion 4 such as the steering wheel. The steering angle sensor 19 is configured by using, for example, a hall element. The ECU 14 acquires the steering amount of the steering portion 4 by the driver, the steering amount of each of the wheels 3 in automatic steering, and the like from the steering angle sensor 19 and executes various controls. The steering angle sensor 19 detects a rotation angle of a rotating portion included in the steering portion 4. The steering angle sensor 19 is an example of an angle sensor.

The accelerator sensor 20 is, for example, a sensor that detects a position of a movable portion of the acceleration operation portion 5. The accelerator sensor 20 can detect a position of the accelerator pedal as the movable portion. The accelerator sensor 20 includes a displacement sensor.

The shift sensor 21 is, for example, a sensor that detects a position of a movable portion of the gear shift operation portion 7. The shift sensor 21 can detect a position of a lever, an arm, a button, or the like as the movable portion. The shift sensor 21 may include a displacement sensor or may be configured as a switch.

The wheel speed sensor 22 is a sensor that detects the rotation amounts of the wheels 3 and the numbers of revolutions thereof per unit time. The wheel speed sensor 22 outputs, as sensor values, the numbers of wheel speed pulses indicating the detected numbers of revolutions. The wheel speed sensor 22 can be configured by using, for example, a hall element. The ECU 14 calculates the movement amount of the vehicle 1 based on the sensor values acquired from the wheel speed sensor 22 and executes various controls. The wheel speed sensor 22 can be provided in the brake system 18. In this case, the ECU 14 acquires a detection result by the wheel speed sensor 22 through the brake system 18.

The acceleration sensor 26 is provided in the vehicle 1, for example. The ECU 14 calculates the inclination (pitch angle) of the vehicle 1 in the front-and-rear direction and the inclination (rolling angle) thereof in the right-and-left direction based on signals from the acceleration sensor 26. The pitch angle is an angle indicating the inclination of the vehicle 1 about a right-and-left axis and is 0 degree when the vehicle 1 is present on a horizontal surface (ground or a road surface). The rolling angle is an angle indicating the inclination of the vehicle 1 about a front-and-rear axis and is 0 degree when the vehicle 1 is present on the horizontal surface (the ground or the road surface). That is to say, whether the vehicle 1 is present on a horizontal road surface or on an inclined surface (a road surface with an upward gradient or a road surface with a downward gradient) can be detected. When the ESC is mounted on the vehicle 1, the acceleration sensor 26 that is conventionally mounted on the ESC is used. In the embodiment, the acceleration sensor 26 is not limited and it is sufficient that the sensor is capable of detecting the acceleration of the vehicle 1 in the front-and-rear and right-and-left directions.

The configurations, arrangement, electric connection forms, and the like of the above-described various sensors and actuators are examples and can be variously set (changed).

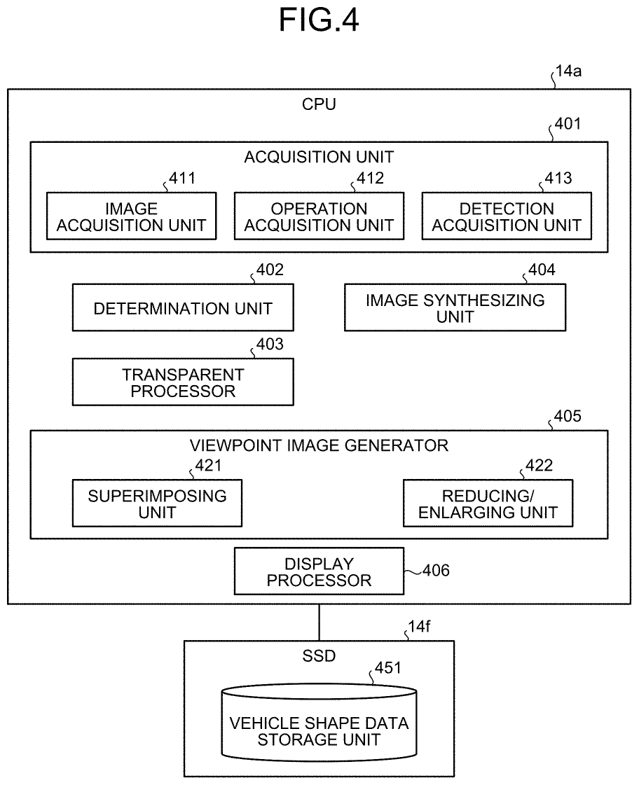

The CPU 14a included in the ECU 14 displays the environment on the periphery of the vehicle 1 based on the pieces of imaged image data as described above. The CPU 14a includes various modules as illustrated in FIG. 4 in order to implement this function. The CPU 14a includes, for example, an acquisition unit 401, a determination unit 402, a transparent processor 403, an image synthesizing unit 404, a viewpoint image generator 405, and a display processor 406. These modules can be implemented by reading the program installed and stored in the storage device such as the ROM 14b and executing the program.

The SSD 14f includes a vehicle shape data storage unit 451 that stores therein vehicle shape data expressing a three-dimensional shape of the vehicle 1, for example. The vehicle shape data stored in the vehicle shape data storage unit 451 holds a shape of an interior of the vehicle 1 in addition to an outer shape of the vehicle 1.

The acquisition unit 401 includes an image acquisition unit 411, an operation acquisition unit 412, and a detection acquisition unit 413, and acquires pieces of information (for example, predetermined data acquired from the outside and the pieces of imaged image data) necessary for displaying the periphery of the vehicle 1.

The image acquisition unit 411 acquires the pieces of imaged image data from the imaging units 15a to 15d that image the periphery of the vehicle 1.

The operation acquisition unit 412 acquires operation data indicating an operation performed by the driver through the operation input portion 10. The operation data can be considered to indicate, for example, an enlargement/reduction operation of a screen displayed on the display device 8 and a viewpoint changing operation for the screen displayed on the display device 8. The operation acquisition unit 412 further acquires operation data indicating a shift operation and steering angle data indicating steering performed by the driver of the vehicle 1 as well. The operation acquisition unit 412 further acquires operation data indicating a blinker lighting operation performed by the driver of the vehicle 1.

The detection acquisition unit 413 acquires detection data from a detector that detects an object on the periphery of the vehicle 1. In the embodiment, as an example of the detector, it can be considered that the imaging units 15a to 15d are stereo cameras and the stereo cameras are used to detect the objects on the periphery of the vehicle 1, or a sonar, a laser, or the like (not illustrated) is used to detect an object on the periphery of the vehicle 1.

The determination unit 402 determines, based on the information acquired by the acquisition unit 401, whether the transparency of the vehicle shape data expressing the vehicle 1 is switched.

The determination unit 402 determines, for example, based on the operation data acquired by the operation acquisition unit 412, whether the transparency of the vehicle shape data expressing the vehicle 1 is switched. When the driver performs the reduction operation or the enlargement operation, for example, the determination unit 402 determines that the transparency should be switched to transparency in response to the reduction operation or the enlargement operation.

As another example, the determination unit 402 determines, based on the detection data acquired by the detection acquisition unit 413, whether the transparency of the vehicle shape data expressing the vehicle 1 is switched. To be specific, the determination unit 402 determines whether a distance between an obstacle detected from the detection data acquired by the detection acquisition unit 413 and the vehicle 1 is within a predetermined value. The determination unit 402 determines, based on a result thereof, whether the transparency of the vehicle shape data expressing the vehicle 1 is switched. When the obstacle is detected, by the detection data, within a predetermined distance in the traveling direction of the vehicle 1, for example, it is considered that the obstacle is easy to be visually checked by increasing the transparency of the vehicle shape data. It should be noted that the predetermined distance is set in accordance with a mode for execution.

The transparent processor 403 performs transparency changing processing or the like on the vehicle shape data stored in the vehicle shape data storage unit 451 based on the determination result by the determination unit 402. In this case, a color of the vehicle shape data may be changed. For example, a color of a region that is the closest to the obstacle may be changed so as to cause the driver to recognize approaching to the obstacle.

The display processor 406 in the embodiment may differentiate the transparency of a region of the vehicle shape data that corresponds to a site of the vehicle 1 near the object detected based on the detection data from the transparency of another region for display when displaying the vehicle shape data. When the determination unit 402 determines that the distance between the obstacle and the vehicle 1 is within the predetermined value, for example, the transparent processor 403 increases the transparency of a partial region of the vehicle shape data that corresponds to the site of the vehicle 1 near the detected obstacle to be higher than the transparency of another region. This processing enables the obstacle to be visually checked easily.

As described above, the display processor 406 in the embodiment can also differentiate the transparency of the partial region of the vehicle shape data from the transparency of another region differing from the partial region for display. The partial region may be any region as long as it is a region in the vehicle shape data. The partial region may be, for example, a region corresponding to the site of the vehicle 1 near the detected object or the bumper and/or the wheels contained in the vehicle shape data. As another example, the display processor 406 may differentiate the transparency of regions expressing the wheels as the partial region from the transparency of a region expressing a roof as another region in the vehicle shape data, for display. Alternatively, in the embodiment, the transparency may be gradually changed from the partial region toward another region. The partial region and the other region in the embodiment may be a region corresponding to one part of the vehicle 1, a region across a plurality of parts, or a region corresponding to a portion in a part.

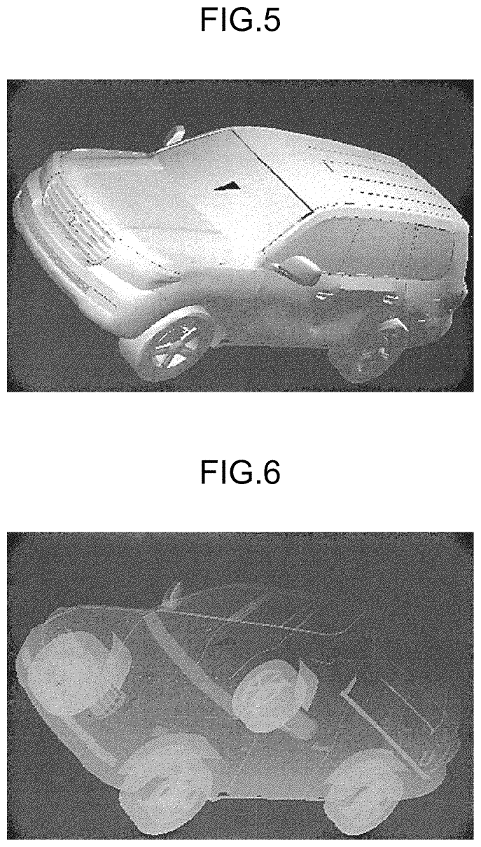

FIG. 5 is a view illustrating the vehicle shape data stored in the vehicle shape data storage unit 451 in the embodiment. The directions of the wheels 3 and the like in the vehicle shape data illustrated in FIG. 5 can be adjusted depending on the steering angle of the vehicle 1.

The transparent processor 403 performs, on the vehicle shape data, transparent processing of providing the switched transparency when the transparency is switched in accordance with the determination result by the determination unit 402. The transparency can be set to a desired value of 0% to 100%.

The transparent processor 403 may switch the transparency of the vehicle shape data depending on a distance between the obstacle detected from the detection data and the vehicle 1, for example, when the transparency is switched in accordance with the determination result by the determination unit 402. The display processor 406 can thereby display the vehicle shape data having the transparency switched depending on the distance.

The determination unit 402 may determine a switching manner of the transparency based on the operation data, for example. When the operation input portion 10 includes a touch panel, the transparency may be switched depending on a period of time during which the vehicle shape data is touched. When, for example, it is determined that the period of touching time is long, the transparent processor 403 may perform the transparent processing so as to increase the transparency. The transparent processor 403 may perform the transparent processing so as to increase the transparency with an increase in the number of times of touching detected by the determination unit 402. As another example, the transparent processor 403 may switch the transparency depending on the intensity of touching detected by the determination unit 402.

When the determination unit 402 determines, based on the operation data, that any region in the vehicle shape data is being touched, the transparent processor 403 may perform processing of increasing (or decreasing) the transparency of the region to be higher than that of the other region.

The transparent processor 403 is not limited to perform the transparent processing on the entire vehicle shape data with the same transparency. The transparency may be made different for each region of the vehicle shape data. It is considered that the transparency of the regions in which the wheels and the like close to the ground are arranged is decreased and the transparency is increased in the regions farther from the ground, for example.

FIG. 6 is a view illustrating the vehicle shape data when a region corresponding to a portion of the vehicle 1 with a height equal to or higher than 2 m is made complete transparent. As illustrated in FIG. 6, the region corresponding to the portion of the vehicle 1 with a height equal to or higher than 2 m is made complete transparent, whereas a region corresponding to a portion of the vehicle 1 with a height lower than 2 m is not made complete transparent and the transparency of the region is decreased downward. In this manner, a display range of the periphery of the vehicle 1 can be enlarged by making the region corresponding to the portion with a height equal to or higher than 2 m complete transparent while enabling situations of the wheels and the ground to be recognized.

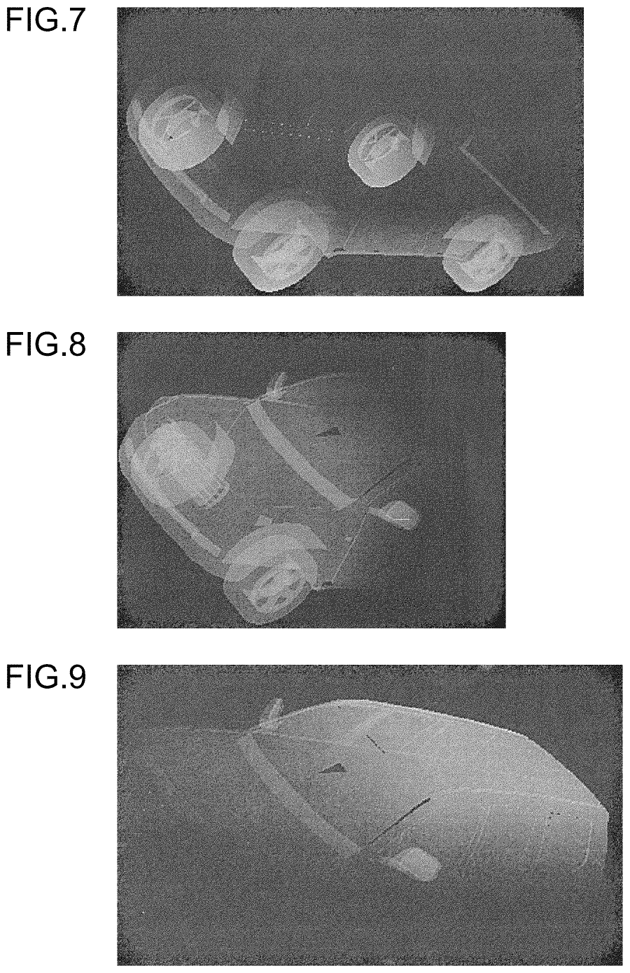

FIG. 7 is a view illustrating the vehicle shape data when a region corresponding to a portion of the vehicle 1 with a height equal to or higher than 1 m is made complete transparent. As illustrated in FIG. 7, the vehicle shape data of the vehicle 1 may be made complete transparent based on whether the height is equal to or higher than 1 m. A reference of the height based on which the vehicle shape data is made complete transparent as illustrated in FIGS. 6 and 7 can be desirably set depending on the height of the vehicle 1 and the situation on the periphery of the vehicle 1.

Thus, the transparent processor 403 may perform the transparent processing of increasing the transparency toward the region expressing the roof from the regions expressing the wheels in the vehicle shape data. With this processing, the display processor 406 displays the vehicle shape data on which the above-mentioned transparent processing has been performed to thereby make the vicinity of the roof of the vehicle 1 complete transparent while displaying the situations of the ground and the vehicle 1. The situation on the periphery of the vehicle 1 can therefore be visually checked. The reference based on which the vehicle shape data is made complete transparent is not limited to the height of the vehicle 1.

FIG. 8 is a view illustrating the vehicle shape data when a region of the vehicle 1 on the rear side relative to a predetermined position is made complete transparent. Display of a region of the vehicle 1 on the front side relative to the predetermined position enables the driver to recognize the situations of the contact surfaces of the wheels in addition to a positional relation between the vehicle 1 and the object present in the traveling direction. The rear side of the vehicle 1 is not necessary for checking the situations in the traveling direction and is therefore made transparent, thereby displaying a wider region of the periphery of the vehicle 1.

In the example illustrated in FIG. 8, the vehicle 1 is assumed to travel forward. When the determination unit 402 determines, based on the operation data acquired by the operation acquisition unit 412, that the shift operation has been performed, the transparent processor 403 may switch a region that is made transparent. When the determination unit 402 determines that the traveling direction has been switched from the forward direction to the backward direction, for example, the transparent processor 403 switches the region that is made complete transparent to the region of the vehicle 1 on the front side relative to the predetermined position from the region of the vehicle 1 on the rear side relative to the predetermined position. The transparent processing depending on the traveling direction can thereby be implemented.

In FIGS. 6 and 7, an example is described in which the region of equal to or higher than a predetermined height T1 is made complete transparent. Alternatively, a region of equal to or lower than the predetermined height T1 may be made complete transparent. FIG. 9 is a view illustrating the vehicle shape data when the predetermined height T1 is 1 m and a region corresponding to a portion of the vehicle 1 with a height equal to or lower than 1 m is made complete transparent. In the example illustrated in FIG. 9, the portion of the vehicle 1 with a height equal to or higher than 1 m is not made complete transparent and the transparency is decreased upward.

The vehicle shape data is superimposed onto the imaged image data provided by shooting the periphery of the vehicle 1. Thus, for example, the display processor 406 in the embodiment can increase or decrease the transparency toward the region expressing the roof (as another region) from the region expressing the wheels (as the partial region) in the vehicle shape data, for display.

With reference to FIG. 4 again, the image synthesizing unit 404 joins the pieces of data of the shot images acquired by the image acquisition unit 411, that is, the pieces of shot image data shot by the imaging units 15 by synthesizing the boundary portions thereof to generate one shot image data.

The image synthesizing unit 404 synthesizes the pieces of imaged image data so as to project the pieces of shot image data on a virtual projection surface surrounding the periphery of the vehicle 1.

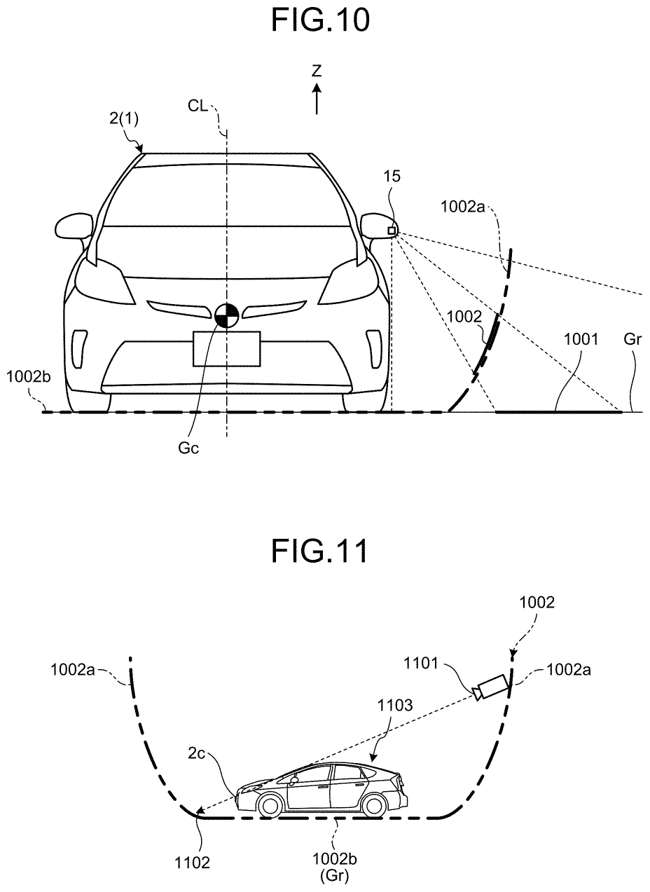

FIG. 10 is an exemplary and schematic descriptive view for explaining projection of shot image data 1001 on a virtual projection surface 1002 in the image synthesizing unit 404. In the example of FIG. 10, the virtual projection surface 1002 has a bottom surface 1002b along ground Gr and a side surface 1002a rising from the bottom surface 1002b, that is, the ground Gr. The ground Gr is a horizontal surface orthogonal to an up-down direction Z of the vehicle 1 and is also a contact surface of tires. The bottom surface 1002b is a substantially circular flat surface and is a horizontal surface with reference to the vehicle 1. The side surface 1002a is a curved surface making contact with the bottom surface 1002b.

As illustrated in FIG. 10, a shape of a virtual cross section of the side surface 1002a that passes through a center Gc of the vehicle 1 and is perpendicular to the vehicle 1 is, for example, an elliptical shape or a parabolic shape. The side surface 1002a is configured as, for example, a rotating surface about a center line CL that passes through the center Gc of the vehicle 1 and is along the up-down direction of the vehicle 1, and surrounds the periphery of the vehicle 1. The image synthesizing unit 404 generates synthesized image data by projecting the shot image data 1001 onto the virtual projection surface 1002.

The viewpoint image generator 405 includes a superimposing unit 421 and a reducing/enlarging unit 422, and generates, from the synthesized image data projected onto the virtual projection surface 1002, viewpoint image data when seen from a predetermined virtual viewpoint. In the embodiment, an example is described in which the viewpoint image data when seen from a predetermined viewpoint is generated after the synthesized image is generated. Alternatively, only the viewpoint image data may be generated using a look up table for performing these pieces of processing at a time.

FIG. 11 is a schematic and exemplary side view illustrating vehicle shape data 1103 and the virtual projection surface 1002. As illustrated in FIG. 11, the superimposing unit 421 superimposes, on the virtual projection surface 1002, the vehicle shape data 1103 on which the transparent processor 403 has performed the transparent processing. The viewpoint image generator 405 converts the synthesized image data projected onto the virtual projection surface 1002 into the viewpoint image data when a gazing point 1102 is seen from a viewpoint 1101. The gazing point 1102 is a point serving as the center of a display region of the viewpoint image data.

The user can desirably set the viewpoint 1101. The viewpoint is not limited to be located outside the vehicle shape data 1103 and may be set in the vehicle shape data 1103. In the embodiment, the viewpoint image generator 405 generates the viewpoint image data from the viewpoint set based on the operation data that the operation acquisition unit 412 acquires.

The reducing/enlarging unit 422 performs processing of making the viewpoint 1101 close to or farther from the vehicle shape data 1103 based on the operation data to thereby perform reduction/enlargement processing on the vehicle shape data 1103 expressed in the viewpoint image data that the viewpoint image generator 405 generates.

The user can desirably set the gazing point 1102 as well. When an enlargement operation is performed based on the operation data that the operation acquisition unit 412 acquires, for example, the reducing/enlarging unit 422 may perform processing of moving the gazing point 1102 indicating the point serving as the center of display to predetermined coordinates. When the user performs the enlargement operation, for example, it is supposed that the user desires to view the situations of the wheels and the ground Gr and the reducing/enlarging unit 422 performs processing of moving the gazing point 1102 to the contact point between the wheel and the ground Gr. Although a case in which the coordinates as a movement destination of the gazing point 1102 correspond to the contact point between the wheel and the ground Gr is described in the embodiment, a position with the coordinates of the movement destination is, however, not limited and proper coordinates are set in accordance with the mode for execution.

In the enlargement display based on the operation data, the display processor 406 therefore switches the transparency (for example, the current transparency) before the enlargement operation to higher transparency and displays the viewpoint image data in which the gazing point is moved to the predetermined coordinates. Movement of the gazing point to coordinates that is considered that the driver desires to check enables the vehicle shape data and the periphery of the vehicle to be displayed in response to the operation of the driver, thereby improving the convenience.

The display processor 406 performs processing of displaying the viewpoint image data generated by the viewpoint image generator 405. In the embodiment, an example is described in which the viewpoint image data is displayed on the display device 8. The viewpoint image data is, however, not limited to be displayed on the display device 8, and may be displayed on, for example, a head up display (HUD).

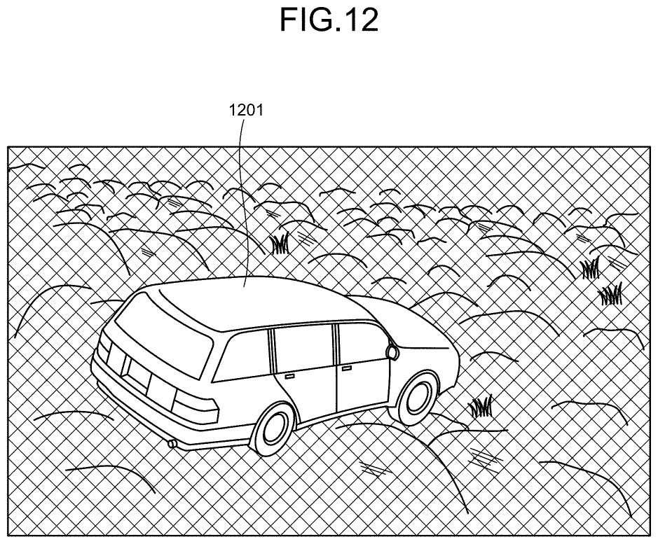

FIG. 12 is a view illustrating an example of the viewpoint image data that the display processor 406 displays. In the example illustrated in FIG. 12, vehicle shape data 1201 on which the transparent processor 403 has performed the processing with the transparency of 0% has been superimposed. The vehicle shape data 1201 illustrated in FIG. 12 is an example in which the vehicle shape data 1201 is not made transparent and a situation on the opposite side cannot therefore be checked.

By contrast, the display processor 406 in the embodiment differentiates the transparency of a partial region of the vehicle shape data from the transparency of another region for display when it displays the viewpoint image data provided by superimposing, in accordance with the current position of the vehicle 1, the vehicle shape data on the synthesized image data expressing the periphery of the vehicle based on the pieces of imaged image data. Then, a display example of the viewpoint image data in which the transparency of the partial region of the vehicle shape data is differentiated from the transparency of another region will be described. Although in the embodiment, an example is described in which the vehicle shape data is superimposed in accordance with the current position of the vehicle 1, it may be superimposed at another position. For example, the vehicle shape data may be superimposed at a position on an estimated course of the vehicle 1 or superimposed at a past position of the vehicle 1.

Next, the viewpoint image data that the display processor 406 displays when the determination unit 402 determines that the portion of the vehicle 1 with a height equal to or higher than the predetermined height T1 is made transparent will be described.

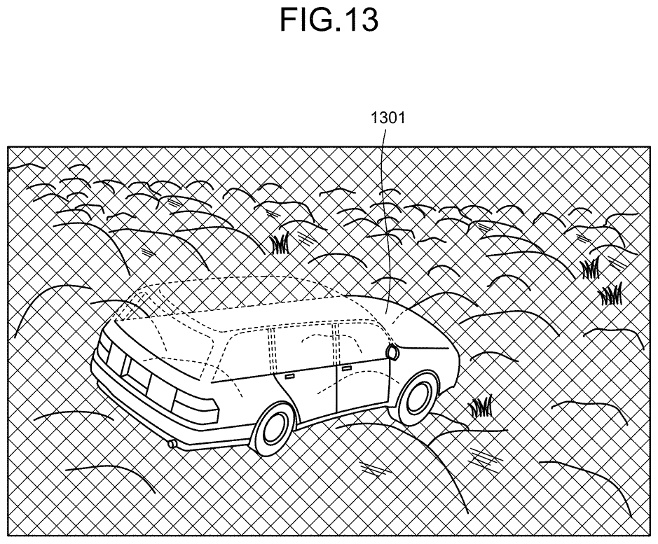

FIG. 13 is a view illustrating another example of the viewpoint image data that the display processor 406 displays. In the example illustrated in FIG. 13, vehicle shape data 1301 on which the transparent processor 403 has performed the processing on the portion equal to or higher than the predetermined height T1 with transparency K1 and on the portion lower than the height T1 with transparency K2 (K1>K2>0%) has been superimposed. As described above, the transparency of the portion the vehicle shape data with a height lower than the predetermined height is low, so that a positional relation between the vehicle 1 and the ground can be recognized. The lower portion is made transparent with the transparency K2, and the situation on the opposite side of the vehicle 1 can also be recognized to some extent. On the other hand, the transparency of the portion of the vehicle shape data with a height equal to or higher than the predetermined height T1 is high, so that the situation on the opposite side of the vehicle 1 can be checked more specifically. The driver can thereby recognize the situation in a wider region.

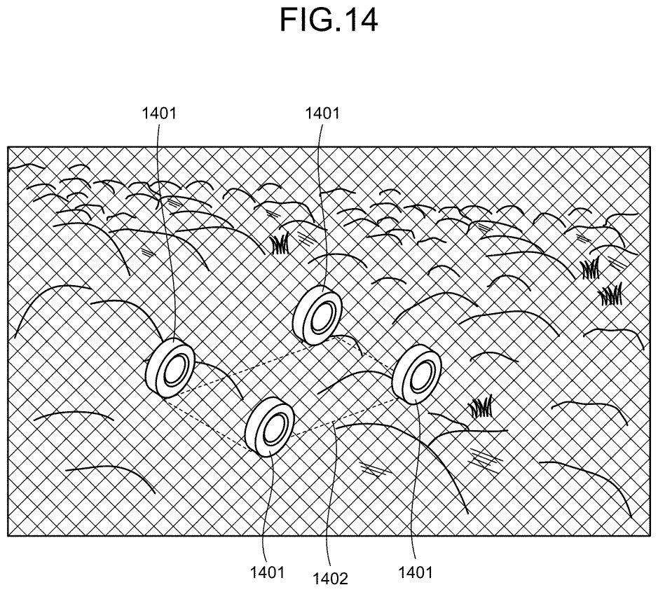

As another method of differentiating the transparency, the transparency may be made different for each component of the vehicle 1. FIG. 14 is a view illustrating another example of the viewpoint image data that the display processor 406 displays. In the example illustrated in FIG. 14, the vehicle shape data on which the transparent processor 403 has performed the processing on regions 1401 corresponding to the wheels with the transparency of 0% and on the region other than the wheels with the transparency of 100% has been superimposed.

The display is considered to be made when the driver performs an operation for displaying only the wheels, for example. The determination unit 402 determines that the region other than the regions of the wheels is made 100% transparent based on the operation data indicating display of the wheels. The transparent processor 403 performs the above-mentioned transparent processing in accordance with the determination result. In the embodiment, an example is described in which only the wheels are displayed. The component to be displayed is, however, not limited to only the wheels among the components of the vehicle 1 and the bumper or the like may be displayed together with the wheels. In the embodiment, a case is described in which the transparency of the regions corresponding to the wheels is set to 0% and the transparency of the other region is set to 100%. It is, however, sufficient that the transparency of the regions corresponding to the wheels is higher than the transparency of the other region.

Thus, the display processor 406 in the embodiment can display the vehicle shape data on which the transparent processing has been performed such that the transparency of a region corresponding to equal to or more than one of the bumper and the wheels (as the partial region) is lower than the transparency of the other region of the vehicle 1. Although a case in which the transparent processing is performed such that the transparency of the region corresponding to equal to or more than one of the bumper and the wheels (as the partial region) is lower than the transparency of the other region is described in the embodiment, the transparent processing may be performed such that the transparency of the region corresponding to equal to or more than one of the bumper and the wheels is higher than the transparency of the other region.

The embodiment is not limited to the above-mentioned transparent processing that is performed based on the operation data. When the determination unit 402 determines, based on the detection data acquired by the detection acquisition unit 413, that the vehicle is during off-road traveling, for example, the transparent processor 403 may perform the transparent processing such that the transparency of the region corresponding to equal to or more than one of the wheels and the bumper is lower than the transparency of the other region, as illustrated in FIG. 14.

In the embodiment, an example is described in which the transparency is switched based on the operation data or the detection data when the vehicle shape data is superimposed and displayed, in accordance with the current position of the vehicle, on display data expressing the periphery of the vehicle based on the pieces of imaged image data. The data for switching the transparency is not limited to the operation data and the detection data, and it is sufficient that the data is predetermined data acquired from the outside.

The imaging units 15 of the vehicle 1 at the current position cannot image a region 1402. In the embodiment, the image synthesizing unit 404 synthesizes, as the synthesized image data, the pieces of imaged image data imaged by the imaging units 15 in the past. As the pieces of imaged image data imaged by the imaging units 15 in the past, pieces of imaged image data imaged when the vehicle 1 was located at a backward position relative to the current position by 2 m can be considered to be used. The above-mentioned pieces of imaged image data may be used as the pieces of imaged image data provided by shooting an underfloor situation of the vehicle 1. The region 1402 is not limited to be displayed by using the pieces of image data imaged in the past and may be filled with a predetermined color simply.

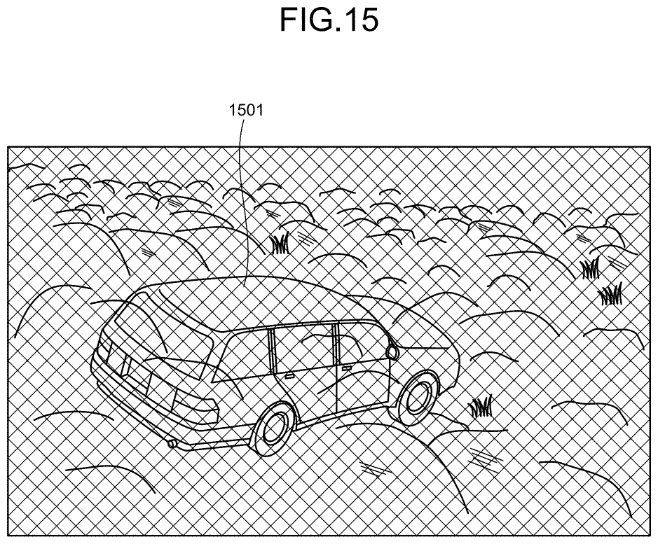

FIG. 15 is a view illustrating another example of the viewpoint image data that the display processor 406 displays. In the example illustrated in FIG. 15, vehicle shape data 1501 on which the transparent processor 403 has performed the processing with the transparency of 100% while excluding lines of the vehicle shape data has been superimposed. The vehicle shape data is thereby made transparent, so that a situation of the periphery of the vehicle 1 can be checked. It is considered that the display illustrated in FIG. 15 is made when the user selects “display only lines of the vehicle”, for example.

In the examples illustrated in FIGS. 13 to 15, cases are described in which the viewpoint is arranged outside the vehicle (vehicle shape data). The embodiment is, however, not limited to the case in which the viewpoint is arranged outside the vehicle (vehicle shape data).

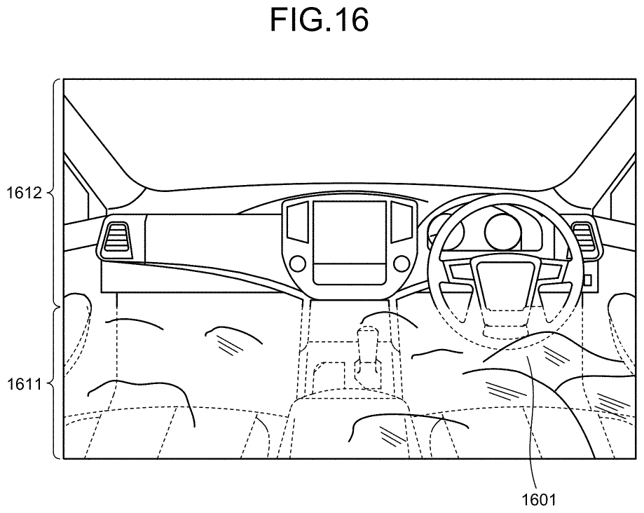

FIG. 16 is a view illustrating another example of the viewpoint image data that the display processor 406 displays. In the example illustrated in FIG. 16, the viewpoint is arranged in the vehicle shape data. The periphery of the vehicle 1 is therefore displayed through the interior that is contained in the vehicle shape data. It is considered that the display illustrated in FIG. 16 is made when the user performs a viewpoint operation, for example.

In the example illustrated in FIG. 16, in interior display of the vehicle 1 with the vehicle shape data, the transparency of a region lower than a predetermined height T2 is set to be higher than the transparency of a region higher than the predetermined height T2. That is to say, when the inside of the vehicle 1 is displayed, transparency K3 of a region 1611 lower than the predetermined height T2 is increased in order to enable the driver to recognize a situation of an object (for example, a rock 1601) present on the ground. On the other hand, transparency K4 of a region 1612 higher than the predetermined height T2 is decreased so as to enable the driver to recognize that the region 1612 is in the vehicle (transparency K3>transparency K4).

That is to say, when the operation of moving the viewpoint to the inside of the vehicle shape data is performed, the display processor 406 displays the viewpoint image data expressing the periphery of the vehicle through the interior of the vehicle from the viewpoint. When the above-mentioned viewpoint image data is displayed, the display processor 406 displays the viewpoint image data expressing the periphery of the vehicle 1 through the vehicle shape data on which the transparent processor 403 has performed the transparent processing of decreasing the transparency toward the ceiling from an underfloor portion in the interior. Although in the embodiment, an example is described in which the transparent processor 403 performs the transparent processing of decreasing the transparency toward the ceiling from the underfloor portion in the interior, the transparent processor 403 may perform the transparent processing of increasing the transparency toward the ceiling from the underfloor portion.

As described above, the display processor 406 in the embodiment differentiates transparent modes of the vehicle shape data between the case in which the viewpoint is located in the vehicle shape data and the case in which the viewpoint is located outside the vehicle shape data.

The determination unit 402 determines, based on the operation data acquired by the operation acquisition unit 412, whether the viewpoint is in the vehicle shape data (vehicle 1) by the operation performed by the user. When the determination unit 402 determines that the viewpoint is in the vehicle shape data (vehicle 1), the transparent processor 403 sets the transparency such that the transparency K3 of the region lower than the predetermined height T2 is higher than the transparency K4 of the region higher than the predetermined height T2, and then, performs the transparent processing. On the other hand, when the determination unit 402 determines that the viewpoint is outside the vehicle shape data (vehicle 1), the transparent processor 403 sets the transparency such that the transparency K2 of the region lower than the predetermined height T1 is lower than the transparency K1 of the region higher than the predetermined height T1, and then, performs the transparent processing. As described above, in the embodiment, switching control of the transparent processing is performed depending on whether the viewpoint is in the vehicle shape data (vehicle 1).

Furthermore, when the viewpoint is in the vehicle shape data (vehicle 1), the transparent processor 403 may switch a region that is made transparent based on vehicle speed information, shift operation data, and blinker information, or other information acquired by the acquisition unit 401. When the determination unit 402 determines that the traveling direction has been switched by the shift operation, the transparent processor 403 may perform processing of making a region on the traveling direction side transparent.

As another example, when the determination unit 402 determines, based on the steering angle data or the operation data indicating the blinker lighting operation, that the driver has performed right steering or left steering, the transparent processor 403 performs the transparent processing of increasing the transparency of a partial region of the vehicle shape data in the direction of the turning side of the vehicle 1 to be higher than the transparency of the other region in the direction of the opposite side. The display processor 406 displays the vehicle shape data having higher transparency on the turning direction side of the vehicle 1, thereby easily checking, through the vehicle shape data, the periphery on the turning direction side.

In the embodiment, an example is described in which the transparent processing of increasing the transparency of the partial region in the direction of the turning side of the vehicle 1 to be higher than the transparency of the other region in the direction of the opposite side is performed. It is, however, sufficient that the transparency of the partial region in the direction of the turning side is differentiated from the transparency of the other region in the direction of the opposite side. For example, the transparent processing of decreasing the transparency of the partial region in the direction of the turning side to be lower than the transparency of the other region in the direction of the opposite side may be performed.

Furthermore, when the determination unit 402 detects touch on a predetermined region based on the operation data, a screen to be displayed may be switched. When the determination unit 402 determines that a dead angle region in the vehicle shape data displayed on the display device 8 has been touched, for example, the display processor 406 may control to display, as an underfloor image of the vehicle 1, the pieces of image data imaged (in the past) when the vehicle 1 was located at a backward position by 2 m, for example.

When the determination unit 402 determines, based on the operation data, that any region in the vehicle shape data is touched, the display processor 406 may perform display processing of making the region brighter by increasing brightness values around the region as if the region is lightened by what is called virtual light.

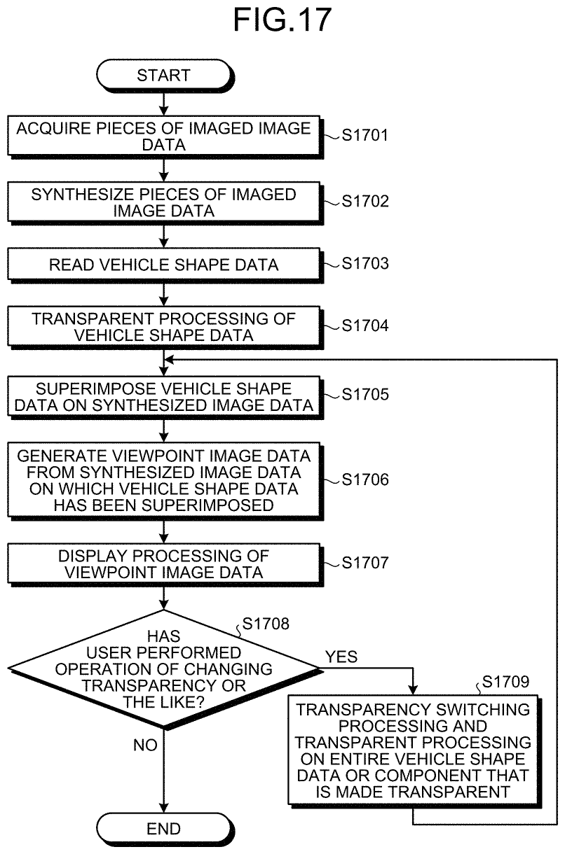

Next, first display processing in the ECU 14 in the embodiment will be described. FIG. 17 is a flowchart illustrating procedures of the above-mentioned processing in the ECU 14 in the embodiment.

First, the image acquisition unit 411 acquires the pieces of imaged image data from the imaging units 15a to 15d that image the periphery of the vehicle 1 (S1701).

Then, the image synthesizing unit 404 synthesizes the pieces of shot image data acquired by the image acquisition unit 411 to generate one synthesized image data (S1702).

The transparent processor 403 reads the vehicle shape data stored in the vehicle shape data storage unit 451 of the SSD 14f (S1703).

The transparent processor 403 performs the transparent processing on the vehicle shape data with predetermined transparency (S1704). The predetermined transparency is set to a predetermined value in accordance with initial values of the viewpoint and the gazing point.

Subsequently, the superimposing unit 421 superimposes, on the synthesized image data, the vehicle shape data on which the transparent processing has been performed (S1705).

Then, the viewpoint image generator 405 generates the viewpoint image data from the synthesized image data on which the vehicle shape data has been superimposed based on the initial values of the viewpoint and the gazing point (S1706).

The display processor 406 displays the viewpoint image data on the display device 8 (S1707).

Subsequently, the determination unit 402 determines, based on the operation data acquired by the operation acquisition unit 412, whether a user has performed the transparency changing operation or the operation of switching a component that is made transparent after the viewpoint image data is displayed (S1708).

When it is determined that the transparency changing operation or the operation of switching the component that is made transparent has been performed (Yes at S1708), the transparent processor 403 performs the switching processing of the changed transparency on the vehicle shape data and performs the transparent processing on the entire vehicle shape data or the component (for example, components other than the wheels and the bumper) that is made transparent in accordance with the switching operation (S1709). Thereafter, the pieces of processing from S1705 are performed.

On the other hand, when it is determined that the transparency changing operation or the operation of switching the component that is made transparent has not been performed (No at S1708), the processing is ended.

In the processing procedures illustrated in FIG. 17, the component that is made transparent or the transparency is switched in accordance with the operation performed by the user. The transparency switching and the like are not, however, limited to be performed based on the operation performed by the user. The case in which the transparency or the like is switched depending on a distance between the vehicle 1 and an obstacle will be described.

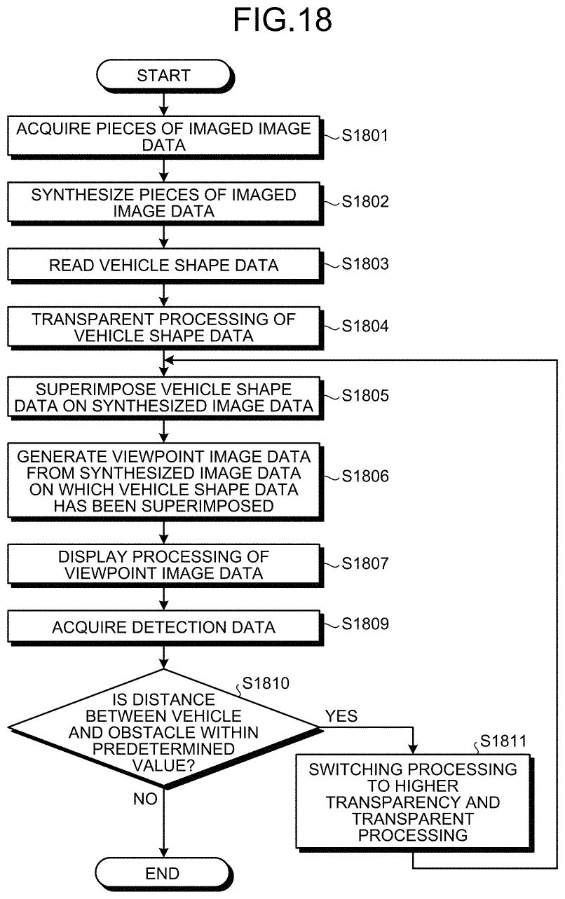

Next, second display processing in the ECU 14 in the embodiment will be described. FIG. 18 is a flowchart illustrating procedures of the above-mentioned processing in the ECU 14 in the embodiment.

In the flowchart illustrated in FIG. 18, pieces of processing of S1801 to S1807 are the same as the pieces of processing of S1701 to S1707 illustrated in FIG. 17 and description thereof is omitted.

The detection acquisition unit 413 acquires detection data from a sonar, a laser, or the like (S1809).

The determination unit 402 determines, based on the detection data, whether a distance between the vehicle 1 and an obstacle present in the traveling direction of the vehicle 1 is within a predetermined value (S1810).

When it is determined that the distance between the vehicle 1 and the obstacle present in the traveling direction of the vehicle 1 is within the predetermined value (Yes at S1810), the transparent processor 403 performs processing of switching transparency of the entire vehicle shape data or a region close to the obstacle to be higher than the transparency set before the detection and performs the transparent processing on the entire vehicle shape data or the region close to the obstacle (S1811). Thereafter, the pieces of processing from 51805 are performed. The predetermined value is considered to be, for example, a distance with which the obstacle comes into a dead angle region with the vehicle and the driver getting in the vehicle 1 cannot therefore see the obstacle. It is, however, sufficient that the predetermined value is set to an appropriate value depending on the mode for execution.

On the other hand, when it is determined that the distance between the vehicle 1 and the obstacle present in the traveling direction of the vehicle 1 is not within the predetermined value (No at S1810), the processing is ended.

In the embodiment, the transparency is not limited to be changed when the user has directly operated the transparency, and the transparency may be changed in accordance with another operation. The case in which the transparency is changed depending on a reduction/enlargement ratio will be described. The following cases are considered. That is, when the vehicle is desired to be enlarged and displayed, it is supposed that a relation between the vehicle 1 and the ground is desired to be checked and the transparency is decreased. When the vehicle is desired to be reduced and displayed, it is supposed that the periphery of the vehicle 1 is desired to be checked and the transparency is increased.

In the embodiment, with the above-mentioned processing, the vehicle shape data and the periphery of the vehicle 1 can be displayed depending on the current situation by switching the transparency of the vehicle shape data based on a positional relation between the object on the periphery of the vehicle 1 and the vehicle 1, thereby improving the convenience.

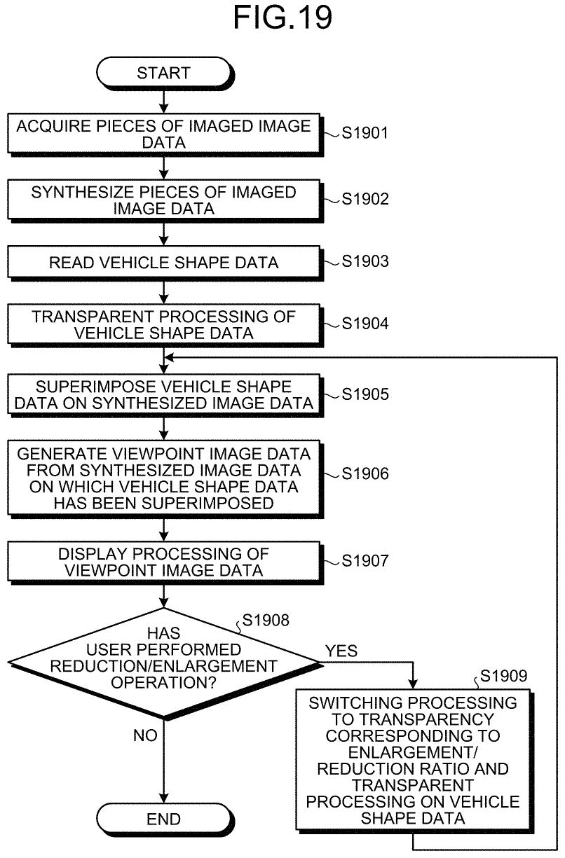

Next, third display processing in the ECU 14 in the embodiment will be described. FIG. 19 is a flowchart illustrating procedures of the above-mentioned processing in the ECU 14 in the embodiment.

In the flowchart illustrated in FIG. 19, pieces of processing of S1901 to S1907 are the same as the pieces of processing of S1701 to S1707 illustrated in FIG. 17 and description thereof is omitted.

The determination unit 402 determines, based on the operation data acquired by the operation acquisition unit 412, whether the user has performed a reduction/enlargement operation (in other words, an operation of making a viewpoint close to or farther from the vehicle shape data) after the viewpoint image data is displayed (S1908).

When it is determined that the reduction/enlargement operation has been performed (Yes at S1908), the transparent processor 403 performs the switching processing to transparency corresponding to a reduction/enlargement ratio on the vehicle shape data and performs the transparent processing on the vehicle shape data (S1909). It is assumed that a correspondence relation between the reduction/enlargement ratio and the transparency is previously set. Thereafter, the pieces of processing from 51905 are performed.

After that, at 51906, the reducing/enlarging unit 422 sets positions of the gazing point and the viewpoint depending on the reduction/enlargement ratio when the viewpoint image data is generated. Then, the viewpoint image generator 405 generates the viewpoint image data based on the gazing point and the viewpoint that have been set.

When the enlargement processing is performed, the viewpoint image generator 405 may perform processing of moving the gazing point to a predetermined position in accordance with the enlargement ratio. That is to say, when the user performs the enlargement operation, it is difficult to set the position of the gazing point in some cases. Furthermore, when the user performs the enlargement operation, the user desires to check a situation between the vehicle and the ground in many cases. In view of these points, in the embodiment, when the enlargement operation is performed, control is performed such that the gazing point is moved to a contact point between the wheel and the ground in accordance with the enlargement processing. An operation until a place that the user desires to check is displayed can be made easy.

On the other hand, when it is determined that the reduction/enlargement operation has not been performed at S1908 (No at S1908), the processing is ended.

As described above, in the enlargement display based on the operation data, the display processor 406 in the embodiment displays the viewpoint image data on which the vehicle shape data switched to have higher transparency than the transparency before the enlargement operation has been superimposed. On the other hand, in the reduction display based on the operation data, the display processor 406 displays the viewpoint image data on which the vehicle shape data switched to have lower transparency than the transparency before the reduction operation has been superimposed.

The embodiment describes an example of the switching of the transparency. In the enlargement display or the reduction display, it is sufficient that the display processor 406 can display the viewpoint image data on which the vehicle shape data switched to have transparency differing from the transparency of the vehicle shape data before the enlargement operation or the reduction operation has been superimposed.

In the embodiment, with the above-mentioned processing, the vehicle shape data and the periphery of the vehicle can be displayed in response to the operation by the driver, by switching the transparency depending on the enlargement operation or the reduction operation by the driver, thereby improving the convenience.

In the above-mentioned embodiment, as illustrated in FIG. 20, an example is described in which the contact point between the wheel and the ground is set as a reference position and a distance from the reference position in the perpendicular direction is the height of the vehicle 1. For example, when the transparency of a region equal to or higher than the height T3 (at a position higher than the wheels and the bumper) from the reference position is set to 80% and a region lower than the height T3 is set to 0%, the transparency of an upper region of the vehicle shape data corresponding to the region equal to or higher than T3 is 80% whereas the wheels, the bumper, and the like can be displayed and visually checked.

In the embodiment, when the determination unit 402 determines that the pieces of imaged image data imaged by the imaging units 15 are abnormal, for example, it may issue an instruction to the transparent processor 403 so as not to perform the transparent processing.

### First Modification

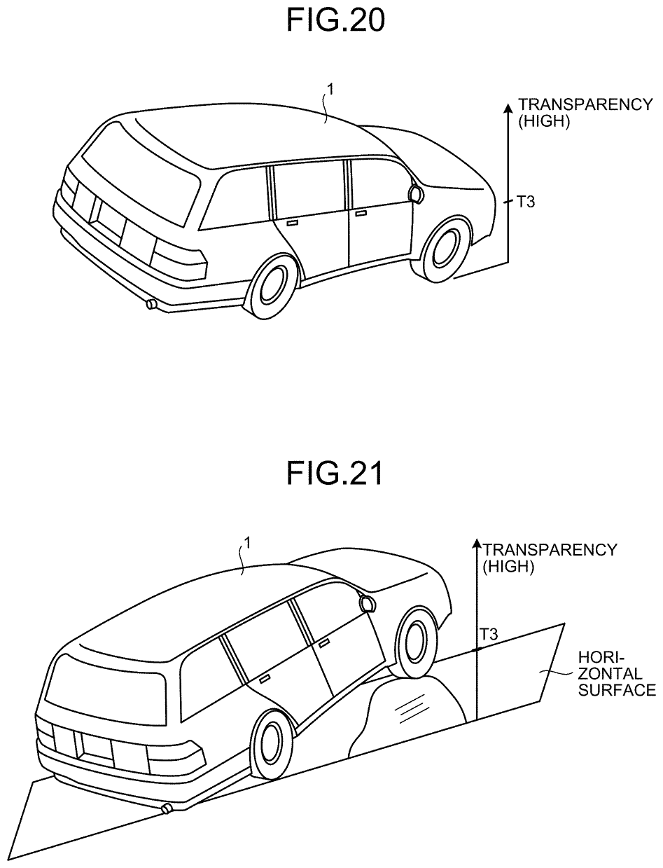

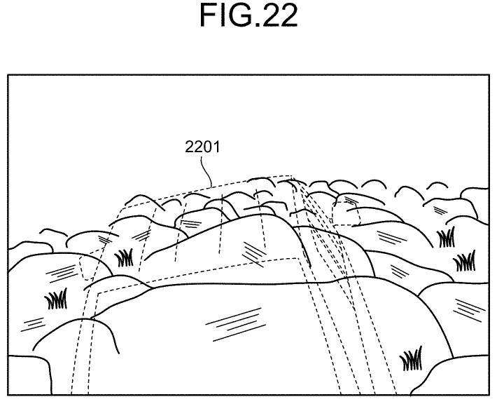

FIG. 21 is a view illustrating an example in which a horizontal surface on which the vehicle 1 is present is a reference and a distance from the horizontal surface in the perpendicular direction is the height of the vehicle. In the example illustrated in FIG. 21, the detection acquisition unit 413 detects the inclination of the vehicle 1 based on the acceleration information acquired from the acceleration sensor 26. The transparent processor 403 estimates a position of the horizontal surface on which the vehicle 1 contacts with the ground based on the inclination of the vehicle 1. The transparent processor 403 performs the transparent processing on the vehicle shape data based on the height from the horizontal surface. When the transparency of a region higher than the height T3 from the horizontal surface is set to 80%, in the example illustrated in FIG. 21, the transparency of a front region of the vehicle shape data containing the wheels and the bumper is 80% under the condition that the vehicle 1 rides on a rock.

FIG. 22 is a view illustrating a display screen that the display processor 406 in the modification displays. In the example illustrated in FIG. 22, when the transparency of the region higher than the height T3 from the horizontal surface is set to 80%, the front region of the vehicle shape data containing the wheels and the bumper is made substantially transparent in riding of the vehicle 1 on the rock.

As illustrated in FIG. 22, when the vehicle 1 rides on the rock, the front region of vehicle shape data 2201 containing the wheels and the bumper is made substantially transparent, thereby easily recognizing the situation of the ground.

### Second Modification

In the above-mentioned embodiment and modification, the processing when the current situation is displayed has been described. The embodiment and modifications are not, however, limited to the examples in which the current situation is displayed. For example, the display processor 406 may display a screen expressing a past situation of the vehicle 1 based on an operation by a user. In this case, the pieces of imaged image data that the image synthesizing unit 404 has synthesized in the past are used, and the transparent processor 403 differentiates the color of the vehicle shape data, and then, performs the transparent processing. The transparent processing is similar to that in the above-mentioned embodiment. The color of the vehicle shape data is a color indicating that the corresponding region expresses the past situation, such as gray or sepia. The user can thereby check that the past situation is displayed.

### Third Modification

In a third modification, an example is described in which the transparent processing (of increasing the transparency to be higher) is performed in enlargement, reduction, or rotation. In the third modification, when the operation acquisition unit 412 acquires operation data indicating enlargement, reduction, or rotation, the transparent processor 403 performs the transparent processing with higher transparency (for example, complete transparency) than transparency before the operation indicating the enlargement, the reduction, or the rotation is performed while the determination unit 402 determines that the driver performs the enlargement, reduction, or rotation operation.

That is to say, in the modification, while the driver performs the enlargement, reduction, or rotation operation (it is sufficient that the operation is an operation of moving the vehicle shape data), the display processor 406 displays the viewpoint image data on which the vehicle shape data switched to have higher transparency than transparency before the enlargement, reduction, or rotation operation has been superimposed. In this case, in the same manner as the above-mentioned embodiment, the processing of moving the gazing point to a predetermined position may be performed in accordance with the enlargement ratio.

The user can thereby intuitively recognize the operation and check the periphery of the vehicle 1 to achieve operability for more appropriate display.

When the display processor 406 in the third modification performs display for movement of the vehicle shape data (for example, with the enlargement/reduction or rotation operation) based on the operation data, it displays the viewpoint image data on which the vehicle shape data switched to have higher transparency than the current transparency has been superimposed.

### Fourth Modification

In the above-mentioned embodiment and modifications, examples are described in which the viewpoint image data is displayed on the display device 8. The above-mentioned embodiment and modifications are not, however, limited to the example in which the viewpoint image data is displayed on the display device 8. In this modification, an example in which the viewpoint image data can be displayed on a head up display (HUD) will be described. In the fourth modification, the transparency is changed depending on a display destination of the viewpoint image data.

When the operation acquisition unit 412 acquires operation data indicating switching of the display destination or the like, for example, the determination unit 402 determines whether the display destination has been switched. The transparent processor 403 performs the transparent processing based on a determination result. That is to say, the display device 8 and the HUD are different in contrast and the transparent processing is therefore performed with transparency with which the user can easily view the viewpoint image data depending on the display destination. The transparency for each display destination is set to an appropriate value depending on display performance of each of the display device 8 and the HUD.

Thus, the display processor 406 in the fourth modification displays the viewpoint image data on which the vehicle shape data having the transparency switched depending on the display destination has been superimposed. With this configuration, the transparency is switched depending on the display destination, thereby visually checking the viewpoint image data easily.

In the above-mentioned embodiment and modifications, the transparency of the partial region of the vehicle shape data is differentiated from that of the other region for display, so that the driver can check the situations of the partial region or the other region and visually check the periphery of the vehicle 1. Thus, the driver can check the situation of the vehicle 1 and easily check the situation of the periphery of the vehicle 1.

In the above-mentioned embodiment and modifications, the vehicle shape data and the periphery of the vehicle 1 can be displayed depending on the current situation by switching the transparency of the vehicle shape data based on the acquired data, thereby improving the convenience.

Although some embodiments of the present invention have been described, the embodiments are examples and are not intended to limit the scope of the invention. These novel embodiments can be implemented in various other forms, and various omissions, replacements, and changes can be made without departing from the gist of the invention. The above-mentioned embodiments and modifications thereof are encompassed in the scope and gist of the invention and are encompassed in a range of the invention according to the claims and equivalents thereof.

1. A display control apparatus comprising:
an acquisition unit configured to acquire predetermined data and imaged image data from an imaging unit that images a periphery of a vehicle;
a storage unit configured to store therein vehicle shape data expressing a three-dimensional shape of the vehicle; and
a display processor configured to switch transparency of the vehicle shape data based on the predetermined data when the vehicle shape data is superimposed and displayed on display data expressing the periphery of the vehicle based on the imaged image data.

2. The display control apparatus according to claim 1, wherein
the acquisition unit acquires, as the predetermined data, detection data from a detector configured to detect an object on the periphery of the vehicle, and
the display processor switches the transparency of the vehicle shape data when a determination unit, which is configured to determine whether a distance between the object detected from the detection data and the vehicle is within a predetermined value, determines that the distance is within the predetermined value.

3. The display control apparatus according to claim 2, wherein the display processor switches the transparency of the vehicle shape data depending on the distance.

4. The display control apparatus according to claim 1, wherein
the acquisition unit acquires, as the predetermined data, operation data indicating an enlargement operation or a reduction operation, and
the display processor displays, when the operation data is acquired, the display data on which the vehicle shape data switched to have transparency differing from the transparency of the vehicle shape data before the enlargement operation or the reduction operation has been superimposed.

5. The display control apparatus according to claim 4, wherein,
when enlarging and displaying the display data based on the operation data, the display processor displays the display data on which the vehicle shape data switched to have higher transparency than the transparency before the enlargement operation has been superimposed,
when reducing and displaying the display data based on the operation data, the display processor displays the display data on which the vehicle shape data switched to have lower transparency than the transparency before the reduction operation has been superimposed.

6. The display control apparatus according to claim 4, wherein, when enlarging and displaying the display data based on the operation data, the display processor moves a gazing point indicating a point serving as a center of display to predetermined coordinates.

7. The display control apparatus according to claim 4, wherein, while an operation of moving the vehicle shape data is performed based on the operation data, the display processor displays the display data on which the vehicle shape data switched to have higher transparency than the transparency before the operation has been superimposed.

8. The display control apparatus according to claim 1, wherein the display processor displays the vehicle shape data having the transparency switched depending on a display destination on which the display data is displayed.
